(19) United States
(12) Patent Application Publication
(10) Pub. No.: US 2025/0374247 A1
(43) Pub. Date: Dec. 4, 2025

(54) Reusing Physical Uplink Control Channel Resources

(71) Applicant: Dell Products L.P., Round Rock, TX (US)

(72) Inventors: Jayaram Venguduswamy Srinivasan, Nepean (CA); Sunil Kumar, Bangalore (IN); Eran Goldstein, Montreal (CA)

(21) Appl. No.: 18/679,067

(22) Filed: May 30, 2024

(51) Int. Cl. H04W 72/0446; H04W 72/21

(52) U.S. Cl. CPC H04W 72/0446; H04W 72/21

(57) ABSTRACT

A system can, in connection with broadband cellular communications with a user equipment, allocate uplink data to a radio network temporary identifier, which corresponds to the user equipment, for physical uplink shared channel resources, wherein the physical uplink shared channel resources correspond to a slot. The system can, based on determining that the slot is used to transmit a channel status information reference signal payload, mark a corresponding resource unused for a physical uplink control channel. The system can receive data from the user equipment using the corresponding resource.

### BACKGROUND

A broadband cellular network can facilitate data transfer with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, in connection with broadband cellular communications with a user equipment, allocate uplink data to a radio network temporary identifier, which corresponds to the user equipment, for physical uplink shared channel resources, wherein the physical uplink shared channel resources correspond to a slot. The system can, based on determining that the slot is used to transmit a channel status information reference signal payload, mark a corresponding resource unused for a physical uplink control channel. The system can receive data from the user equipment using the corresponding resource.

An example method can comprise allocating, by a system comprising at least one processor, uplink data to a radio network temporary identifier, which corresponds to a user equipment, for physical uplink shared channel resources, where the physical uplink shared channel resources correspond to a slot. The method can further comprise, based on determining that the slot is used to transmit information about a status of the user equipment, marking, by the system, a corresponding resource unused for a physical uplink control channel. The method can further comprise receiving, by the system, data from the user equipment using the corresponding resource.

An example non-transitory computer-readable medium can comprise instructions that, in response to execution, cause a system comprising a processor to perform operations. These operations can comprise allocating uplink data to an identifier corresponds to a device, for physical uplink shared channel resources, wherein the physical uplink shared channel resources correspond to a slot. These operations can further comprise, based on determining that the slot is used to transmit information about a status of the device, marking a corresponding resource unused for a physical uplink control channel. These operations can further comprise receiving data from the device using the corresponding resource.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate reusing physical uplink control channel (PUCCH) resources, in accordance with an embodiment of this disclosure;

FIG. 2 illustrates an example system architecture of a slot pattern for different uplink channels, and that can facilitate reusing PUCCH resources, in accordance with an embodiment of this disclosure;

FIG. 3 illustrates an example system architecture of combining PUCCH resources with physical uplink shared channel (PUSCH) resources, and that can facilitate reusing PUCCH resources, in accordance with an embodiment of this disclosure;

FIG. 4 illustrates an example system architecture of combining PUCCH resources with common PUCCH resources, and that can facilitate reusing PUCCH resources, in accordance with an embodiment of this disclosure;

FIG. 5 illustrates an example process flow that can facilitate reusing PUCCH resources, in accordance with an embodiment of this disclosure;

FIG. 6 illustrates another example process flow that can facilitate reusing PUCCH resources, in accordance with an embodiment of this disclosure;

FIG. 7 illustrates another example process flow that can facilitate reusing PUCCH resources, in accordance with an embodiment of this disclosure;

FIG. 8 illustrates another example process flow that can facilitate reusing PUCCH resources, in accordance with an embodiment of this disclosure;

FIG. 9 illustrates another example process flow that can facilitate reusing PUCCH resources, in accordance with an embodiment of this disclosure;

FIG. 10 illustrates an example block diagram of a computer operable to execute an embodiment of this disclosure.

### DETAILED DESCRIPTION

### Overview

The present examples generally relate to fifth generation (5G) broadband cellular networks. It can be appreciated that the present techniques can be applied to other types of broadband networks, such as sixth generation (6G) broadband cellular networks.

PUCCH can generally comprise a communications channel that is configured to carry uplink control information (UCI) from a UE to a gNB. There can be different formats for PUCCH communications, such as format 0, format 1, format 2, format 3, and format 4.

A physical uplink shared channel (PUSCH) can generally comprise a communications channel that is configured to carry radio resource control (RRC) signaling messages, UCI, and application data, from a UE to a gNB.

In a fifth generation new radio (5G NR) system, uplink (UL) physical uplink control channel (PUCCH) resources can be pre-configured for a user equipment (UE), and these pre-configured resources can be shared to a UE over radio resource control (RRC) messages. The UE can use this information to transmit a control signal back to a gNodeB (gNB, sometimes referred to as a base station). Control signals can comprise a channel status information reference signal (CSI-RS) report, hybrid automatic repeat request (HARQ) bits, and/or a scheduling request (SR) indication.

In some cases, it can be that some physical resources are not used for transmitting a control signal back to a gNB, and this resource can potentially be reused to carry uplink data.

In some examples, the present techniques can be implemented to facilitate PUCCH formats 3 and 4 resources for data transmission. The present techniques can involve identifying unused resources at runtime; based on a number of unused resources, scheduling data on the resources by the gNB; and optimizing resource allocation to effectively utilize data traffic (which can mitigate a problem of scheduling data).

PUCCH format 3 can be used to transmit control messages of more than 2 bits. In 5G NR, PUCCH format 3 can comprise a format through which a large payload transmission is possible, and it can be that no UE multiplexing is possible with this resource (that is, there can be one UE transmission).

This resource can be used to transmit a CSI-RS payload from a UE to a gNB.

CSI-RS can be configured by a gNB to a UE during an attach procedure. The CSI-RS periodicity can be pre-configured and based on the allocation and number of UEs attached to a network. It can be that every slot of a PUCCH resource (formats 3 or 4) is assigned to a particular radio network temporary identifier (RNTI) for a CSI-RS payload transmission. A RNTI can generally comprise a unique identifier that a gNB assigns to a UE to identify that UE.

When a gNB scheduler allocates uplink data to a RNTI (for physical uplink shared channel (PUSCH) resources), the scheduler can check if the slot is used for CSI-RS payload transmission. Generally, a UL downlink control information (DCI) can be scheduled to a UE to send uplink data traffic. While allocating a PUSCH UL DCI, a scheduler can check the slot, and if the same slot is used to transmit CSI-RS payload, then the scheduler can mark the resource as unused because, on that slot, the UE will send a CSI-RS payload over a PUSCH resource. Since it can be that no other UE can multiplex over PUCCH format 3, that particular slot PUCCH format 3 resource will then be unused.

These principles can be applied to other PUCCH formats, with the following modifications:
Format F2 can be similar to formats F3 and F4, and with a shorter number of orthogonal frequency division multiplexing (OFDM) symbols.
With formats F0 and F1, instead of taking advantage of empty occasions of CSI-RS reports, empty occasions of acknowledgement (ACK) and negative acknowledgment (NACK) can be used, where all multiplexed UEs happen to not be using it at the current slot.

In prior approaches, it can be that unused PUCCH resource blocks are not utilized for data traffic. In contrast, according to the present techniques, the unused resource blocks can be identified and utilized for data traffic, which can increase a system's throughput.

In some examples, an increase in throughput can be a few kilobits per second, which can be used for voice and/or data traffic.

In some examples, a system that implements the present techniques identifies the RNTI, and the corresponding CSI-RS slot once the RNTI is identified, and while scheduling PUSCH resources for the same RNTI on the same slot, a scheduler can mark the PUCCH resource as unused because CSI-RS control data will be transmitted over PUSCH since the RNTI has allocation on the CSI-RS slot. This otherwise-unused resource can be used for PUSCH transmission.

In prior approaches with 5G NR, it can be that uplink PUCCH resources are pre-configured for a UE, and these pre-configured resources are shared to the UE over RRC messages. The UE can use this information to transmit a control signal back to gNB. Examples of control messages are CSI-RS reports, HARQ bits, and SR indications.

Some prior approaches that relate to a Long Term Evolution (LTE) standard reuse PUCCH, but they lack a way to identify the unused PUCCH resource and effectively use it for PUSCH. Additionally, 5G NR technologies have different PUCCH formats compared to LTE.

In 5G NR, it can be that PUCCH formats Format 3 and 4 are a non-multiplexed resource; that is, only one user can use these format in a time slot. The present techniques can be implemented identify the unused PUCCH format 3 and 4 resource at runtime, by comparing the CSI-RS periodicity and PUSCH scheduling, and marking PUCCH format 3 or 4 as unused.

Once the resource is marked as unused, a gNB scheduler can use this resource to schedule the resource for PUSCH transmission.

Another aspect of the present techniques relates to managing a resource cluster, to make sure a PUCCH resource can be located next to a PUSCH resource, which can help in scheduler to combine the unused PUCCH with PUSCH resource blocks. In other examples, a scheduler can use this unused PUCCH resources for IoT devices as a separate resource instead of combining with other PUSCH resources.

It can be that, when UL DCI is missed, a UE will not transmit PUSCH, and control information will be on a PUCCH resource. According to the present techniques, a reused resource (PUCCH resource) can be occupied for PUCCH, which can mean that a decision taken from the scheduler was wrong in allocating PUCCH for PUSCH, and hence the data transferred by an Internet-of-Things (IoT) device or other UE can have CRC failure and it will be resolved as part of regular CRC failure HARQ retransmission.

That is, when UL DCI are not decoded, a gNB will experience a CRC error while decoding PUSCH data, and this can be handled as part of HARQ retransmission.

In other examples, if the unused resource is used for a same RNTI PUSCH data, if UL DCI is missed anyways, it can be that a UE (same RNTI) will not transmit data and CRC will fail for the RNTI.

### Example Architectures

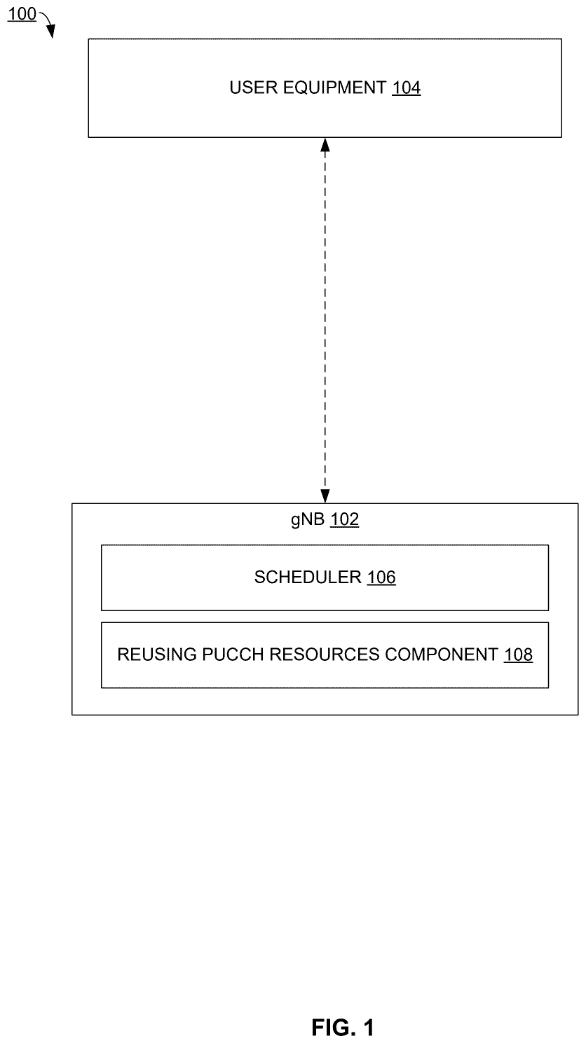

FIG. 1 illustrates an example system architecture 100 that can facilitate reusing PUCCH resources, in accordance with an embodiment of this disclosure.

System architecture 100 comprises gNodeB (gNB) 102 and UE 104. In turn, gNB 102 comprises scheduler 106, and reusing PUCCH resources component 108.

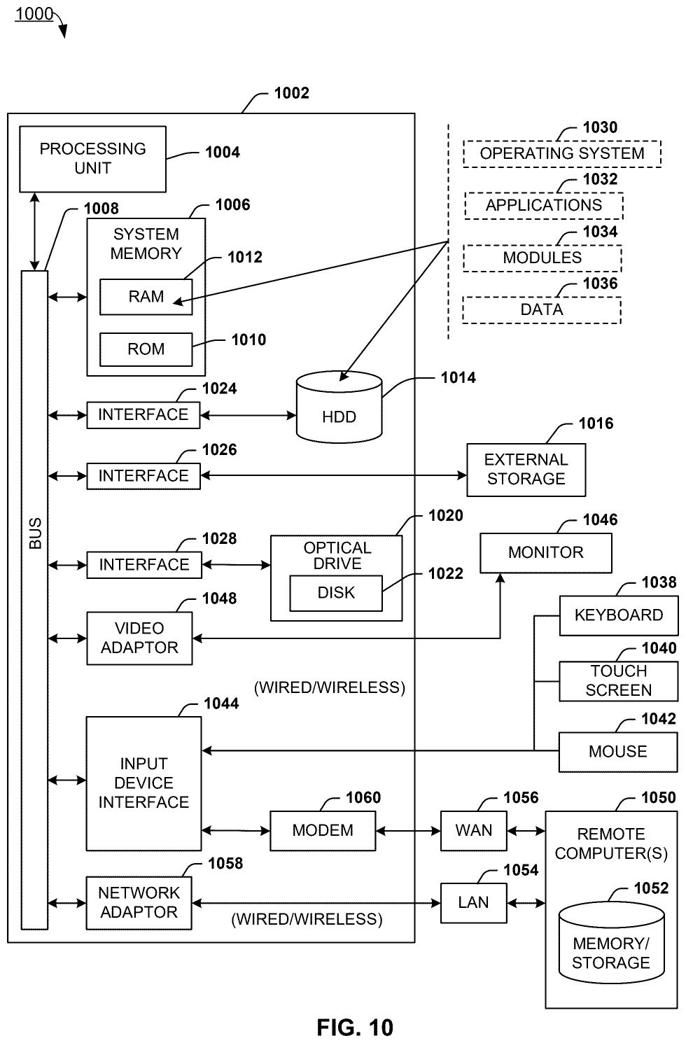

Each of gNB 102 and/or UE 104 can be implemented with part(s) of computing environment 1000 of FIG. 10.

In some cases, it can be that some physical resources are not used for transmitting a control signal from UE 104 back to gNB 102, and this resource can potentially be reused to carry uplink data.

To facilitate this, reusing PUCCH resources component 108 can identify unused resources at runtime; reuse those resources to schedule data on the resources by the gNB with scheduler 106; and optimize resource allocation to effectively utilize data traffic (which can mitigate a problem of scheduling data).

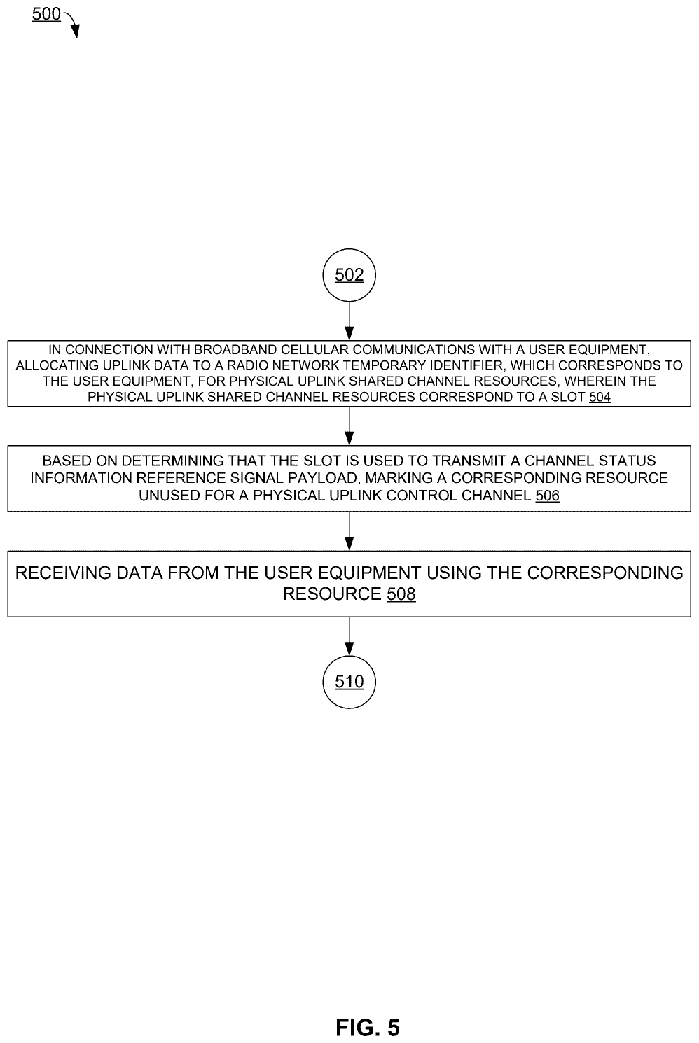

In some examples, reusing PUCCH resources component 108 can implement part(s) of the process flows of FIGS. 5-9 to facilitate reusing PUCCH resources.

It can be appreciated that system architecture 100 is one example system architecture for proactive prevention of data unavailability and data loss, and that there can be other system architectures that facilitate reusing PUCCH resources.

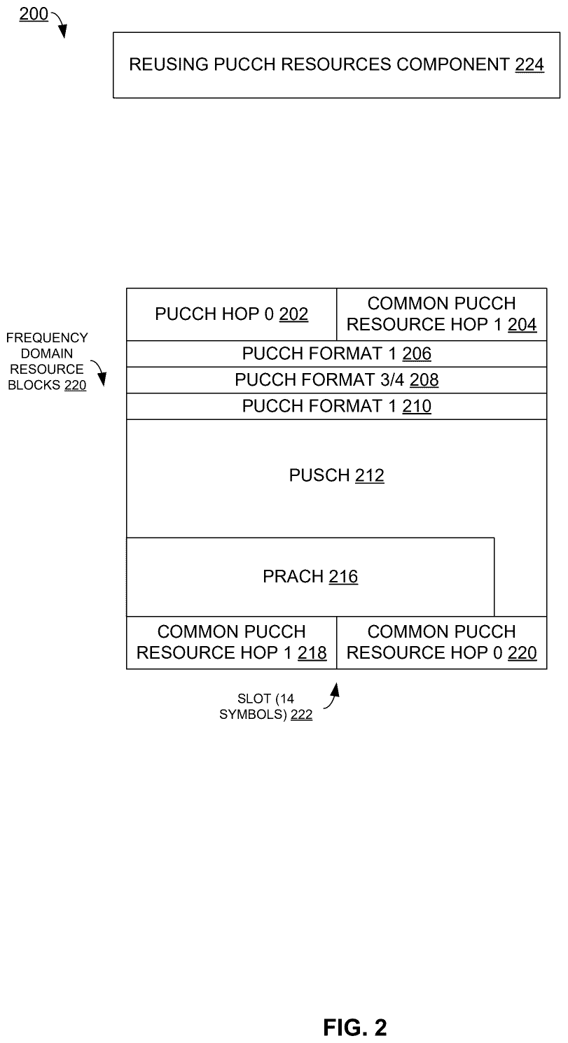

FIG. 2 illustrates an example system architecture 200 of a slot pattern for different uplink channels, and that can facilitate reusing PUCCH resources, in accordance with an embodiment of this disclosure. In some examples, part(s) of system architecture 200 can be implemented by system architecture 100 of FIG. 1 to facilitate reusing PUCCH resources.

An example allocation of uplink PUCCH resources is shown in FIG. 2. FIG. 2 comprises common PUCCH Hop 0 202, common PUCCH resource Hop 1 204, PUCCH format 1 206, PUCCH format 3/4 208, PUCCH format 1 210, PUSCH 212, PRACH 216, common PUCCH resource Hop 1 218, common PUCCH resource Hop 0 220, frequency domain resource blocks 220, slot (14 symbols) 222, and reusing physical uplink control channel resources component 224.

Common PUCCH resources can be used to send control information while a UE is performing an attach sequence. During an attach sequence (or process), a UE can use these resources for sending ACK-NACK information for the downlink messages in the attach process.

Based on a physical random access channel (PRACH) configuration index, a slot can be defined for PRACH. When a PRACH is present in the slot, some resources can be allocated to PRACH.

Some of the resources can be allocated as dedicated PUCCH resources, which can be used dedicatedly by an attached UE that has RNTI assigned to it. In this example, the top of the grid is used for dedicated PUCCH formats. In other examples, it can be aligned anywhere in the grid. In this example, by allocating the resource at the edge (either top or bottom) continuous resources blocks can be obtained without any gaps in between for PUSCH resources.

Remaining unused resources can be used by the scheduler to allocate PUSCH resources for UEs to transmit uplink data.

As part of a configuration message to a UE, a CSI-RS report periodicity and a PUCCH resource to be used for control data transmission can be configured. On a periodic basis, the UE can transmit a CSI-RS report back to a gNB on a PUCCH resource.

When there is a PUSCH allocation and a CSI-RS report period collide, CSI-RS control data can be transferred along with PUSCH data (that is, an uplink control information (UCI) over PUSCH implantation).

In that case, it can be that a PUCCH resource is not utilized on that slot.

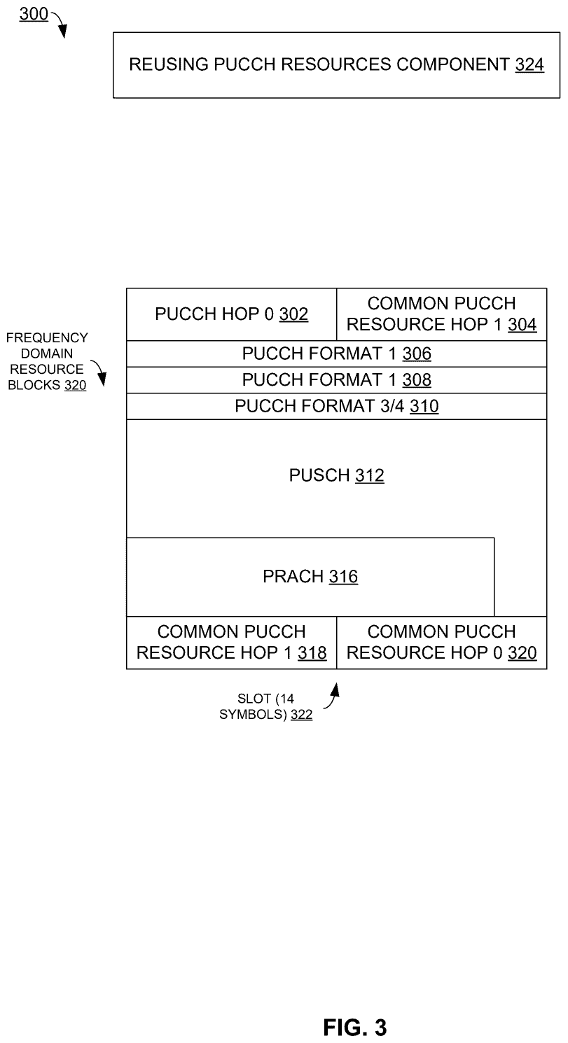

FIG. 3 illustrates an example system architecture 300 of combining PUCCH resources with physical uplink shared channel (PUSCH) resources, and that can facilitate reusing PUCCH resources, in accordance with an embodiment of this disclosure. In some examples, part(s) of system architecture 300 can be implemented by system architecture 100 of FIG. 1 to facilitate reusing PUCCH resources.

The present techniques can be implemented to identify the unused resources on a slot level and utilize those resources for scheduling the data. To identify unused resources, the following can be performed.

While scheduling a grant for a UE (RNTI), a scheduler can check the CSI-RS periodicity for that UE and check if the UE has CSI-RS control data on the slot.

If the slot contains CSI-RS information, the PUCCH resource can be marked as unused in the slot.

While scheduling a grant, if there are no users with TC-RNTI, then the common PUCCH resources can be marked as unused.

The resources identified as being unused can be used for data traffic.

In some examples, where these resources are small, they can be useful for voice or for Internet-of-Things (IoT) devices like smart meters, sensors, etc., which can require relatively few physical resources to send data to an application server in an uplink direction.

Additionally, PUCCH format 3 or 4 resource can be rearranged to combine an unused PUCCH resource along with a PUSCH or common PUCCH resource to increase a number of PUSCH resources available for data transmission, which increases the throughput per slot.

FIG. 3 illustrates an example of combining PUCCH with PUSCH.

FIG. 3 comprises common PUCCH Hop 0 302, common PUCCH resource Hop 1 304, PUCCH format 1 306, PUCCH format 1 308, PUCCH format 3/4 310, PUSCH 312, PRACH 316, common PUCCH resource Hop 1 318, common PUCCH resource Hop 0 320, frequency domain resource blocks 320, slot (14 symbols) 322, and reusing physical uplink control channel resources component 324.

In a case of rearranging a PUCCH format 3 resource along with a PUSCH resource, this can help a scheduler to utilize an unused PUCCH format 3 resource combined with a PUSCH resource for scheduling data on a need basis, or it can use it as an individual resource.

When the unused PUCCH resource is used for a new RNTI grant then the effective utilization of data over that resource can be the transport block (TB) size+cyclic redundancy check (CRC). In this case, CRC additional data can be added for a CRC check, if it is combined with PUSCH, and this resource block is added to an existing PUSCH user, then the existing user can get an additional resource to send data, which can effectively utilize the full resource, with no extra TB CRC added, since TB-CRC can be common per TB data. Hence, rearranging this PUCCH format 3/format 4 resource with PUSCH can add an advantage that the scheduler can make a run time decision to combine the resource with an existing PUSCH user, or use it for new user (RNTI), such as for voice/IoT devices.

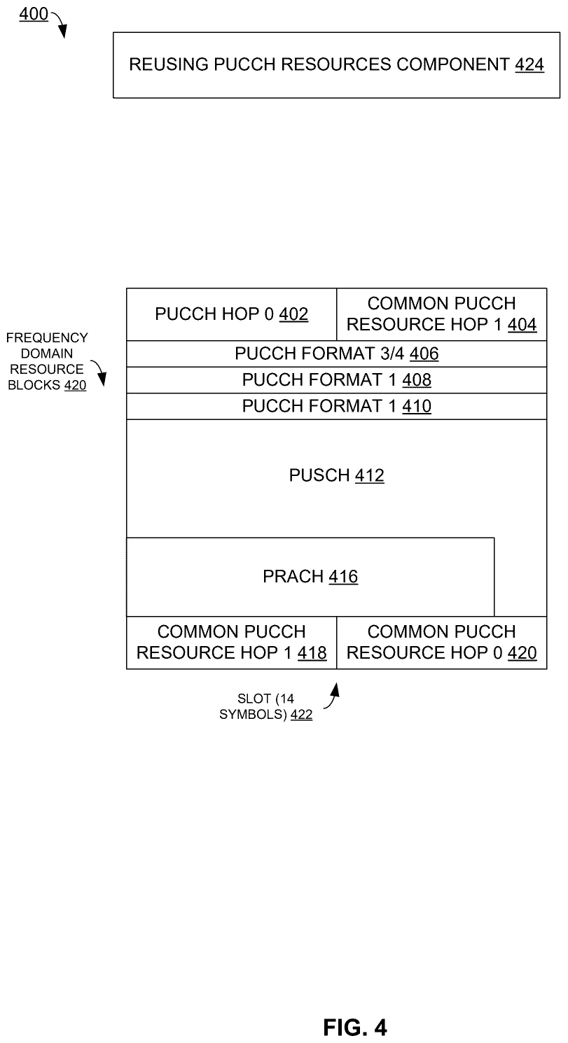

FIG. 4 illustrates an example system architecture 400 of combining PUCCH resources with common PUCCH resources, and that can facilitate reusing PUCCH resources, in accordance with an embodiment of this disclosure. In some examples, part(s) of system architecture 400 can be implemented by system architecture 100 of FIG. 1 to facilitate reusing PUCCH resources.

FIG. 4 illustrates an example of combining PUCCH with a common PUCCH resource.

FIG. 4 comprises common PUCCH Hop 0 402, common PUCCH resource Hop 1 404, PUCCH format 3/4 406, PUCCH format 1 408, PUCCH format 1 410, PUSCH 412, PRACH 416, common PUCCH resource Hop 1 418, common PUCCH resource Hop 0 420, frequency domain resource blocks 420, slot (14 symbols) 422, and reusing physical uplink control channel resources component 424.

In this case, an unused PUCCH format 3 can be combined with a common PUCCH resource when both are identified as an unused resource. This can help a scheduler to allocate additional physical resources to a UE.

Where PUCCH format 3/4 is placed next to common PUCCH resources, a scheduler can identify both that PUCCH format 3/4 is not used, and that common PUCCH resources are unused if there is not a UE attach process occurring.

When the scheduler identifies that both conditions are true, the scheduler can combine PUCCH common and PUCCH format 3/4 together for PUSCH transmission.

The present techniques can be implemented to facilitate identifying an unused resource at runtime. While scheduling a grant for a UE (RNTI), a scheduler can check a CSI-RS periodicity for that UE and check if UE has CSI-RS control data on the slot. If the slot contains CSI-RS information, the PUCCH resource can be marked as unused in the slot. While scheduling a grant, if there are no users with TC-RNTI, then the common PUCCH resources can be marked as unused.

This can be implemented to identify a PUCCH format 3 unused resource. Once resources are identified, a similar approach can be used for scheduling PUSCH data on it.

In some examples, identifying a PUCCH as an unused resource can be a negligible overhead to a scheduler.

Once identified, the resource can be used in other ways, such as for IoT devices, or combining it with other existing PUSCH users.

In addition to these examples relating to PUCCH format 3 (sometimes referred to as F3), similar approaches can be applied to other PUCCH formats, such as with the following modifications:

Format 2 (F2) can be similar to formats F3 and F4, and has a shorter number of orthogonal frequency division multiplexing (OFDM) symbols.

Format 0 (F0) and format 1 (F1), can use empty occasions of ACK/NACK instead of taking advantage of empty occasions of CSI-RS reports. It can be that this can be done if all multiplexed UEs happen to not be using it at the current slot.

### Example Process Flows

FIG. 5 illustrates an example process flow 500 for reusing PUCCH resources, in accordance with an embodiment of this disclosure. In some examples, one or more embodiments of process flow 500 can be implemented by system architecture 100 of FIG. 1, or computing environment 1000 of FIG. 10.

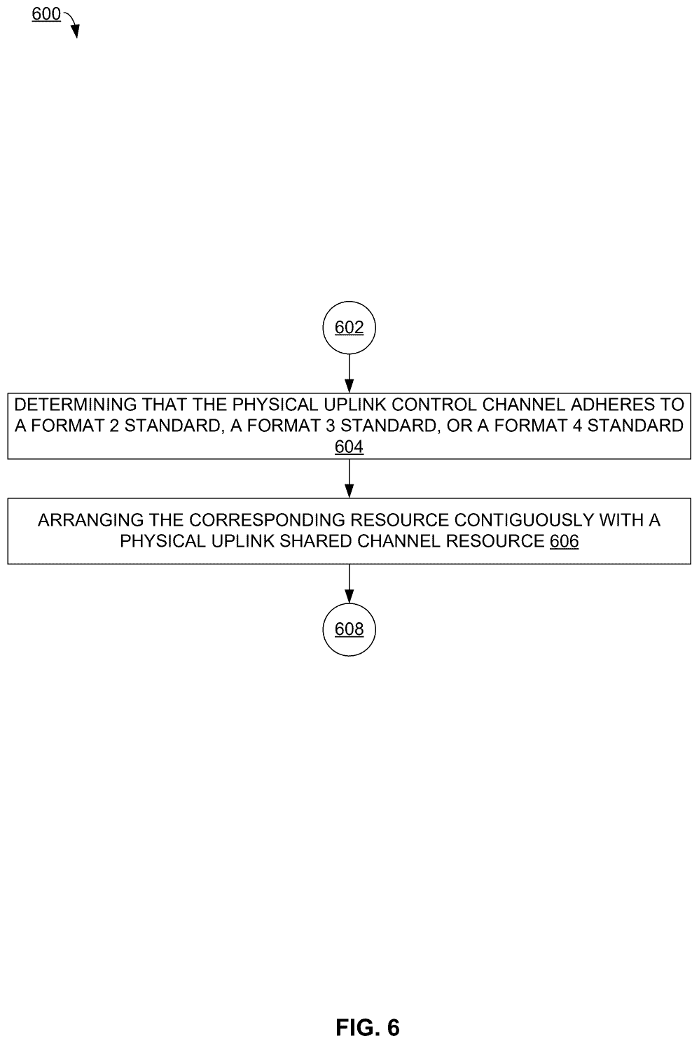

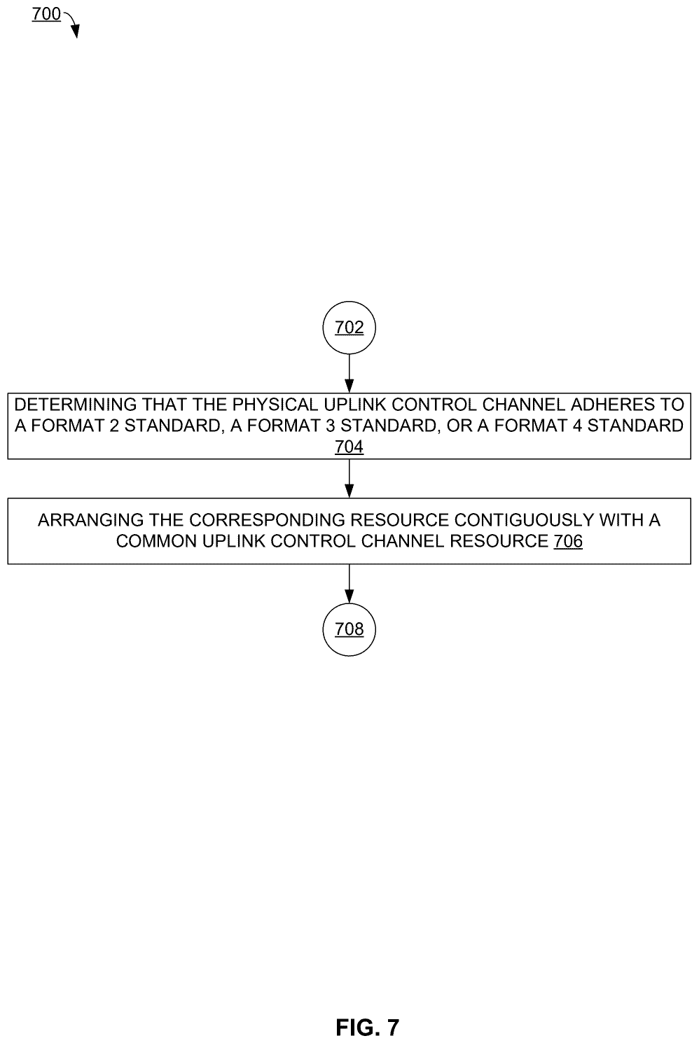

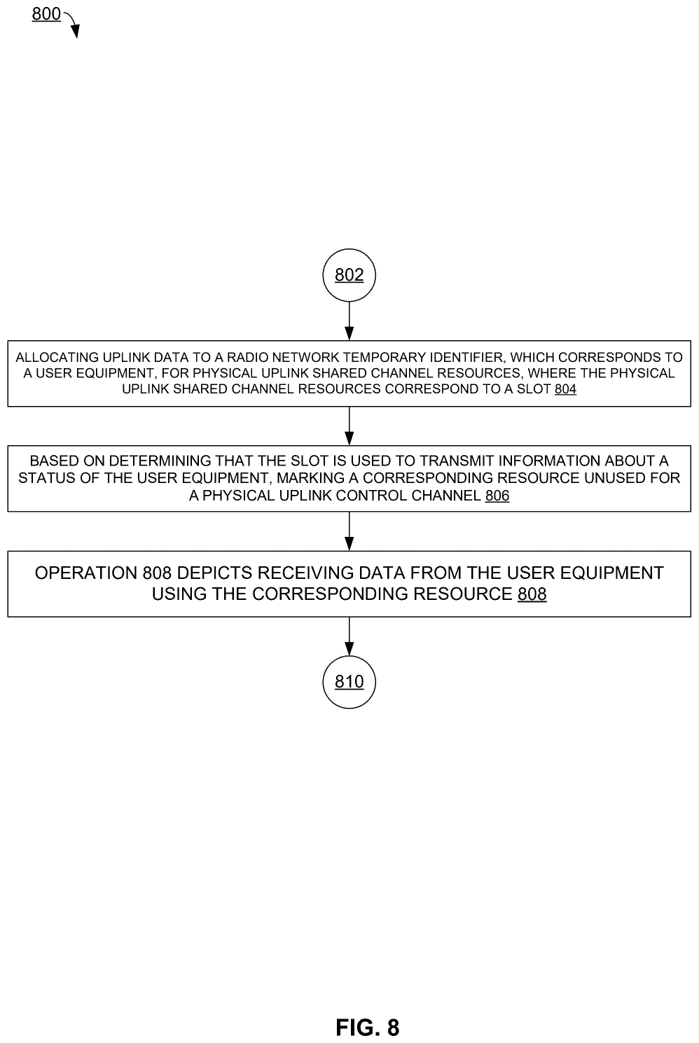

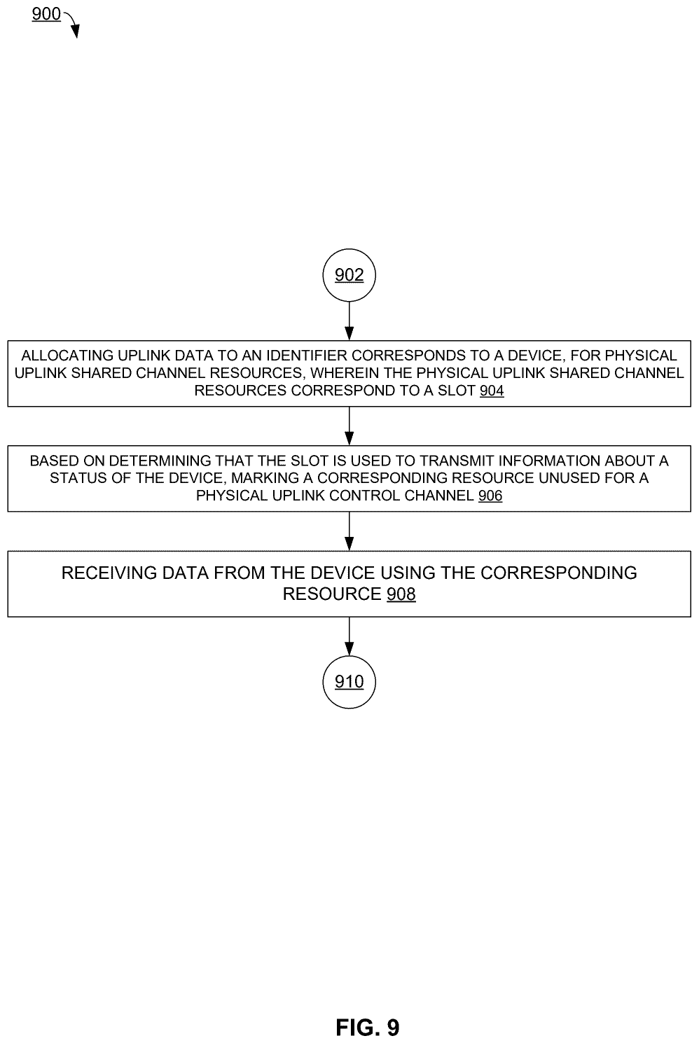

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts, in connection with broadband cellular communications with a user equipment, allocating uplink data to a radio network temporary identifier, which corresponds to the user equipment, for physical uplink shared channel resources, wherein the physical uplink shared channel resources correspond to a slot. That is, there can be broadband cellular communications, and a scheduler of a gNB can check whether a CSI-RS payload transmission slot is used.

After operation 504, process flow 500 moves to operation 506.

Operation 506 depicts, based on determining that the slot is used to transmit a channel status information reference signal payload, marking a corresponding resource unused for a physical uplink control channel. That is, where the CSI-RS payload transmission slot is used, while allocating PUSCH UL DCI, the scheduler can check if the same slot is used to transmit CSI-RS payload. Then, where the same slot is used to transmit CSI-RS payload, the scheduler can mark the resource as unused for PUCCH.

In some examples, the user equipment is a first user equipment, and a format of the physical uplink control channel prohibits multiplexing with a second user equipment. That is, it can be that another UE cannot multiplex over PUCCH format 3.

In some examples, the physical uplink control channel adheres to a format 2 standard, a format 3 standard, or a format 4 standard.

In some examples, the allocating and the marking are performed by a scheduler of the system. That is, a scheduler of a gNB can perform certain operations.

After operation 506, process flow 500 moves to operation 508.

Operation 508 depicts receiving data from the user equipment using the corresponding resource. That is, the resource marked as unused for PUCCH can be used for receiving data from the UE.

After operation 508, process flow 500 moves to 510, where process flow 500 ends.

FIG. 6 illustrates an example process flow 600 for reusing PUCCH resources, in accordance with an embodiment of this disclosure. In some examples, one or more embodiments of process flow 600 can be implemented by system architecture 100 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts determining that the physical uplink control channel adheres to a format 2 standard, a format 3 standard, or a format 4 standard.

After operation 604, process flow 600 moves to operation 606.

Operation 606 depicts arranging the corresponding resource contiguously with a physical uplink shared channel resource. That is, a PUCCH F2, F3, and/or F4 resource can be rearranged to combine an unused PUCCH resource along with a PUSCH resource. This can increase a number of physical resources available to increase throughput on a slot basis.

After operation 606, process flow 600 moves to 608, where process flow 600 ends.

FIG. 7 illustrates an example process flow 700 for reusing PUCCH resources, in accordance with an embodiment of this disclosure. In some examples, one or more embodiments of process flow 700 can be implemented by system architecture 100 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts determining that the physical uplink control channel adheres to a format 2 standard, a format 3 standard, or a format 4 standard.

After operation 704, process flow 700 moves to operation 706.

Operation 706 depicts arranging the corresponding resource contiguously with a common uplink control channel resource. That is, a PUCCH F2, F3, and/or F4 resource can be rearranged to combine an unused PUCCH resource along with a common PUCCH resource. This can increase a number of physical resources available to increase throughput on a slot basis. In some examples, the arranging is performed based on determining that the common uplink control channel resource is unused. That is, it can be that a PUCCH F2, F3, and/or F4 resource can be combined with a common PUCCH resource when both are identified as unused resources.

After operation 706, process flow 700 moves to 708, where process flow 700 ends.

FIG. 8 illustrates an example process flow 800 for reusing PUCCH resources, in accordance with an embodiment of this disclosure. In some examples, one or more embodiments of process flow 800 can be implemented by system architecture 100 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts allocating uplink data to a radio network temporary identifier, which corresponds to a user equipment, for physical uplink shared channel resources, where the physical uplink shared channel resources correspond to a slot. In some examples operation 804 can be implemented in a similar manner as operation 404 of FIG. 4.

After operation 804, process flow 800 moves to operation 806.

Operation 806 depicts, based on determining that the slot is used to transmit information about a status of the user equipment, marking a corresponding resource unused for a physical uplink control channel. In some examples operation 806 can be implemented in a similar manner as operation 406 of FIG. 4.

In some examples, the physical uplink control channel adheres to a format 0 format or a format 1 format, and wherein the information about the status of the user equipment comprises an acknowledgment or a negative acknowledgment. In some examples, the physical uplink control channel is configured to transmit multiplexed information for a group of user equipment that comprises the user equipment, and wherein the marking is performed based on no user equipment of the group of user equipment being determined to be using the slot.

That is PUCCH F0 and F1 can use empty occasions of ACK and NACK, and in some examples do so only if all multiplexed UEs happen to not be using it at the current slot.

In some examples, the physical uplink control channel adheres to a format 2 format, a format 3 format, or a format 4 format, and the information about the status of the user equipment comprises a channel status information reference signal payload. In some examples, the physical uplink control channel prohibits multiplexing.

In some examples, the marking of the corresponding resource as unused is performed based on determining that no temporary cell radio network temporary identifier corresponds to the physical uplink control channel, and the slot corresponds to common physical uplink control channel resources. That is, in some examples, while scheduling a grant, if there are no users with a TC-RNTI, then the common PUCCH resources can be marked as unused.

After operation 806, process flow 800 moves to operation 808.

Operation 808 depicts receiving data from the user equipment using the corresponding resource. In some examples operation 808 can be implemented in a similar manner as operation 408 of FIG. 4.

After operation 808, process flow 800 moves to 810, where process flow 800 ends.

FIG. 9 illustrates an example process flow 900 for reusing PUCCH resources, in accordance with an embodiment of this disclosure. In some examples, one or more embodiments of process flow 900 can be implemented by system architecture 100 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts allocating uplink data to an identifier corresponds to a device, for physical uplink shared channel resources, wherein the physical uplink shared channel resources correspond to a slot. In some examples operation 904 can be implemented in a similar manner as operation 404 of FIG. 4.

In some examples, the identifier comprises a radio network temporary identifier.

After operation 904, process flow 900 moves to operation 906.

Operation 906 depicts, based on determining that the slot is used to transmit information about a status of the device, marking a corresponding resource unused for a physical uplink control channel. In some examples operation 906 can be implemented in a similar manner as operation 406 of FIG. 4.

In some examples, the marking of the corresponding resource unused for the physical uplink control channel is performed based on there being a physical uplink shared channel allocation that corresponds to the device, and a channel status information reference signal period occurring. That is, when there is a PUSCH allocation and a CSI-RS report period collides, CSI-RS control data can be transferred along with PUSCH data (which can be a UCI over PUSCH option).

In some examples, the physical uplink control channel follows to a format 0 format or a format 1 format, and the information about the status of the device comprises an acknowledgment or a negative acknowledgment.

In some examples, the physical uplink control channel is configured to transmit multiplexed information, and the marking is performed where no user equipment is determined to be using the slot.

In some examples, the physical uplink control channel follows a format 2 format, a format 3 format, or a format 4 format, and the information about the status of the device comprises a channel status information reference signal payload.

In some examples, the physical uplink control channel lacks a configuration for multiplexing.

After operation 906, process flow 900 moves to operation 908.

Operation 908 depicts receiving data from the device using the corresponding resource. In some examples operation 908 can be implemented in a similar manner as operation 408 of FIG. 4.

After operation 908, process flow 900 moves to 910, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of gNB 102 and/or UE 104 of FIG. 1.

In some examples, computing environment 1000 can implement one or more embodiments of the process flows of FIGS. 5-9 to use reusing PUCCH resources.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1016 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
in connection with broadband cellular communications with a user equipment,
allocating uplink data to a radio network temporary identifier, which corresponds to the user equipment, for physical uplink shared channel resources, wherein the physical uplink shared channel resources correspond to a slot;
based on determining that the slot is used to transmit a channel status information reference signal payload, marking a corresponding resource unused for a physical uplink control channel; and
receiving data from the user equipment using the corresponding resource.

2. The system of claim 1, wherein the user equipment is a first user equipment, and wherein a format of the physical uplink control channel prohibits multiplexing with a second user equipment.

3. The system of claim 1, wherein the physical uplink control channel adheres to a format 2 standard, a format 3 standard, or a format 4 standard.

4. The system of claim 3, wherein the operations further comprise:
arranging the corresponding resource contiguously with a physical uplink shared channel resource.

5. The system of claim 3, wherein the operations further comprise:
arranging the corresponding resource contiguously with a common uplink control channel resource.

6. The system of claim 5, wherein the arranging is performed based on determining that the common uplink control channel resource is unused.

7. The system of claim 1, wherein the allocating and the marking are performed by a scheduler of the system.

8. A method, comprising:
allocating, by a system comprising at least one processor, uplink data to a radio network temporary identifier, which corresponds to a user equipment, for physical uplink shared channel resources, where the physical uplink shared channel resources correspond to a slot;
based on determining that the slot is used to transmit information about a status of the user equipment, marking, by the system, a corresponding resource unused for a physical uplink control channel; and
receiving, by the system, data from the user equipment using the corresponding resource.

9. The method of claim 8, wherein the physical uplink control channel adheres to a format 0 format or a format 1 format, and wherein the information about the status of the user equipment comprises an acknowledgment or a negative acknowledgment.

10. The method of claim 9, wherein the physical uplink control channel is configured to transmit multiplexed information for a group of user equipment that comprises the user equipment, and wherein the marking is performed based on no user equipment of the group of user equipment being determined to be using the slot.

11. The method of claim 8, wherein the physical uplink control channel adheres to a format 2 format, a format 3 format, or a format 4 format, and wherein the information about the status of the user equipment comprises a channel status information reference signal payload.

12. The method of claim 8, wherein the physical uplink control channel prohibits multiplexing.

13. The method of claim 8, wherein the marking of the corresponding resource as unused is performed based on determining that no temporary cell radio network temporary identifier corresponds to the physical uplink control channel, and wherein the slot corresponds to common physical uplink control channel resources.

14. A non-transitory computer-readable medium comprising instructions that, in response to execution, cause a system comprising at least one processor to perform operations, comprising:
allocating uplink data to an identifier corresponds to a device, for physical uplink shared channel resources, wherein the physical uplink shared channel resources correspond to a slot;
based on determining that the slot is used to transmit information about a status of the device, marking a corresponding resource unused for a physical uplink control channel; and
receiving data from the device using the corresponding resource.

15. The non-transitory computer-readable medium of claim 14, wherein the identifier comprises a radio network temporary identifier.

16. The non-transitory computer-readable medium of claim 14, wherein the marking of the corresponding resource unused for the physical uplink control channel is performed based on there being a physical uplink shared channel allocation that corresponds to the device, and a channel status information reference signal period occurring.

17. The non-transitory computer-readable medium of claim 14, wherein the physical uplink control channel follows to a format 0 format or a format 1 format, and wherein the information about the status of the device comprises an acknowledgment or a negative acknowledgment.

18. The non-transitory computer-readable medium of claim 17, wherein the physical uplink control channel is configured to transmit multiplexed information, and wherein the marking is performed where no user equipment is determined to be using the slot.

19. The non-transitory computer-readable medium of claim 14, wherein the physical uplink control channel follows a format 2 format, a format 3 format, or a format 4 format, and wherein the information about the status of the device comprises a channel status information reference signal payload.

20. The non-transitory computer-readable medium of claim 14, wherein the physical uplink control channel lacks a configuration for multiplexing.
